(19) United States
(12) Patent Application Publication
(10) Pub. No.: US 2015/0242431 A1
(43) Pub. Date: Aug. 27, 2015

(54) COMPUTER SYSTEM LOG FILE ANALYSIS BASED ON FIELD TYPE IDENTIFICATION

(71) Applicant: CA, INC., Islandia, NY (US)

(72) Inventor: Vitezslav Vit Vlcek, Prague (CZ)

(73) Assignee: CA, INC., Islandia, NY (US)

(21) Appl. No.: 14/189,988

(22) Filed: Feb. 25, 2014

(51) Int. Cl. G06F 17/30

(52) U.S. Cl. CPC G06F 17/30144; G06F 17/30988; G06F 17/30867; G06Q 50/01

(57) ABSTRACT

A log file analysis computer includes a processor and a memory coupled to the processor. The memory includes computer readable program code that when executed by the processor causes the processor to perform operations. The operations include accessing a log file containing lines of data entries, and identifying which of the data entries in the log file are associated with which of a plurality of field types. A subset of the data entries in the log file are selected based on the associations between the data entries and the field types. A modified log file is generated based on the subset of the data entries.

### TECHNICAL FIELD

The present disclosure relates to computer systems and more particularly to operational analysis of computer equipment.

### BACKGROUND

Computer systems can output data to log files that sequentially list actions that have been performed and/or list application state information at various checkpoints or when triggered by defined events (e.g., faults) occurrences, etc. For example, some web servers maintain log files that list every request made to the web servers. Users can operate log file analysis tools to attempt to determine the operational characteristics of a computer system, such as how server clients are using application services, where client requests are originating, how often clients return, and how clients navigate through a website, etc.

Two types of log files are application log files and system log files. An application log file can contain events logged by the applications themselves while being executed. What events are written to the application log file can therefore be selected by the application developers. A system log file can contain events that are logged by the operating system components. These events are often defined by the operating system itself, and may contain information about device changes, device drivers, system changes, events, operations and more. Complex computer systems, such as cloud-based servers, can write a large amount of data to log files, especially when faults are occurring.

To troubleshoot or otherwise analyze system operation, a human operator may read through the lengthy sequentially recorded log file data entries using a word processor or browser to attempt to identify important state information or patterns that are indicative of problematic operations. However, log files can have hundreds megabytes of data entries and, hence, can be very difficult to process manually or using known computer tools.

### SUMMARY

Some embodiments disclosed herein are directed to a log file analysis computer that includes a processor and a memory coupled to the processor. The memory includes computer readable program code that when executed by the processor causes the processor to perform operations. The operations include accessing a log file containing lines of data entries, and identifying which of the data entries in the log file are associated with which ones of a plurality of field types. A subset of the data entries in the log file are selected based on the associations between the data entries and the field types. A modified log file is generated based on the subset of the data entries.

In a further embodiment, to identify which of the data entries in the log file are associated with which of a plurality of field types, a local repository of log file characteristics is accessed that contains information defining patterns of field types that are expected to occur in the log file and associated characteristics of the data entries. The field types associated with the data entries in the log file can then be identified based on the information defining patterns of field types that are expected to occur in the log file and associated characteristics of the data entries.

In a further embodiment, to identify which of the data entries in the log file are associated with which of a plurality of field types, a message can be posted on a social media server. The message contains an identifier that is tracked by computer systems and information identifying a characteristic of the log file. Informational postings made by computer systems to the social media server are tracked. One of the informational postings by one of the computer systems is identified as being responsive to the report message. Which of the data entries in the log file are associated with which of the plurality of field types is identified based on content of the identified one of the informational postings.

In a further embodiment, the identifier is selected from among a plurality of defined identifiers, which are separately tracked by computer systems, based on a characteristic of a computer program executed by a computer system that generated the log file. At least a portion of at least one of the lines of data entries in the log file is embedded into a text string of a report message. The report message is communicated to the social media server for publishing to the computer systems which track the identifier.

In a further embodiment, acceptable baseline parameters for possible data entries in log files are selected based on comparison of data entries in a plurality of log files generated over time by a computer system. The selection among the data entries in the log file for inclusion in the subset of the data entries is based on comparison of the data entries in the log file to the acceptable baseline parameters.

In a further embodiment, the subset of the subset of the data entries is imported into a spreadsheet program module. A macro program is generated based on a characteristic of a computer system that generated the log file. The data entries within the spreadsheet program module are ordered based on the macro program.

Related methods in are disclosed. It is noted that aspects described with respect to one embodiment may be incorporated in different embodiments although not specifically described relative thereto. That is, all embodiments and/or features of any embodiments can be combined in any way and/or combination.

### BRIEF DESCRIPTION OF THE DRAWINGS

Aspects of the present disclosure are illustrated by way of example and are not limited by the accompanying drawings. In the drawings:

FIG. 1 is a block diagram of a system containing a log file analysis computer that analyzes log files generated by computer systems in accordance with some embodiments;

FIGS. 2-6 are flowcharts of various operations and methods by a log file analysis computer for analyzing log files in accordance with some embodiments;

FIG. 7 is a block diagram of the log file analysis computer of FIG. 1 configured according to one embodiment;

FIG. 8 illustrates a portion of a log file generated by a computer system;

FIG. 9 illustrates another view of a log file generated by a computer system;

FIGS. 10a and 10b illustrate commands that may be performed by a log parser program executable by a log file analysis computer that can process the log file of FIG. 9 in accordance with some embodiments;

FIG. 11 illustrates a portion of a spreadsheet program that has imported the output from the log parser program of FIGS. 10a and 10b in accordance with some embodiments;

FIG. 12 illustrates another portion of the spreadsheet that has been reformatted to provide a structured view of the data entries imported from the log parser program of FIGS. 10a and 10b in accordance with some embodiments;

FIG. 13 illustrates spreadsheet operations that are performed to filter the data entries based on the sorted field types (represented as column characteristics) in accordance with some embodiments;

FIG. 14 illustrates the filtered data entries displayed with visual indications of rows of the data entries that satisfy defined rules;

FIG. 15 illustrates statistics that are generated to list file systems that have been determined to have been used during operation of the computer system under analysis;

FIG. 16 illustrates a list of data types or other variables associated with the data entries from the log file;

FIG. 17 illustrates operations by which a user has selected one of the displayed lines within the spreadsheet (background window), to cause a corresponding highlighted location with the original log file to be displayed (foreground window), according to some embodiment; and

FIG. 18 illustrates an example overview of the dataflow and operations flow for analyzing a log file according to some embodiment.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

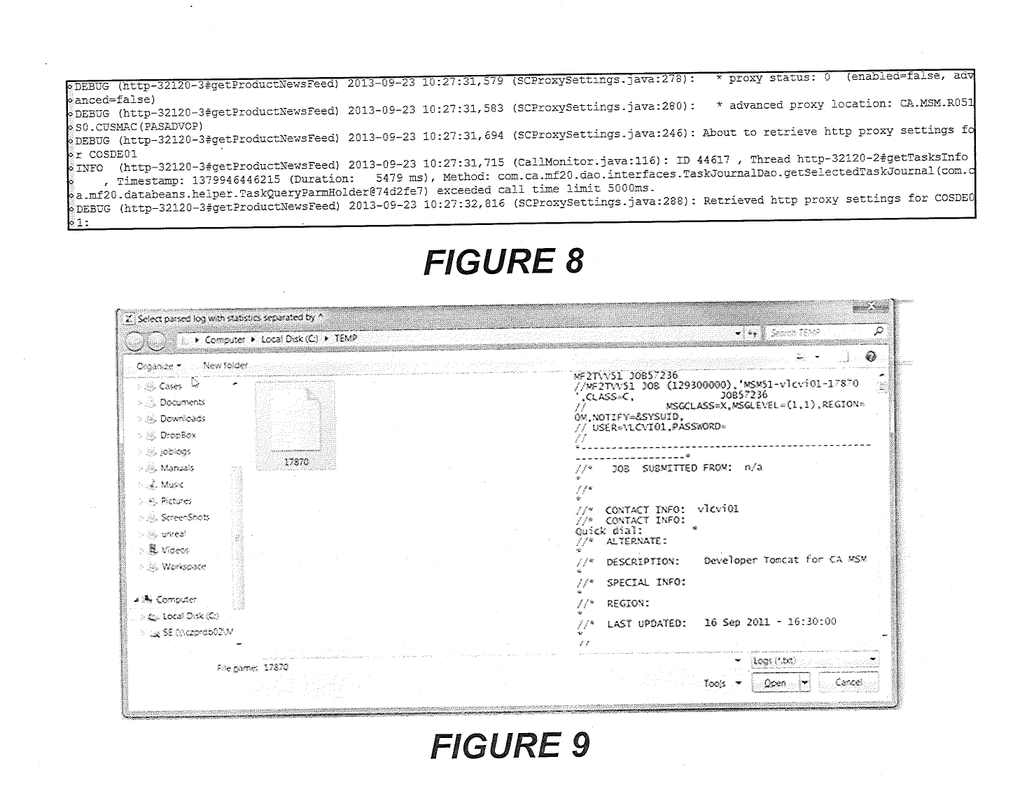

Complex computer systems, such as cloud-based servers, can write a large amount of data to log files, especially when faults are occurring. The data written to a log file can have various meanings and characteristics associated with defined field structures, such as the date of events, time of events, file name of events, type of events, characteristics such as severity of events, etc. The written data can form a sequence of entries logically organized as lines that are split every 133 characters due to, for example, string length constraints. Associations between message entries in the log file and their defined field structures can be obscured or lost because of the line length and other constraints imposed while data is written to the log file or subsequently read there from by a computer tool. For example, FIG. 8 illustrates an example log file where the first line is broken into two lines. It can be difficult for a human operator or computer tool to find the first occurrence of word “advanced”, which has been broken into two lines (lines 1 and 2) when written to the log file. The resulting entries of the log file may therefore not be easily filtered or processed based on the structure of how they exist in the log file. Log files can have hundreds of megabytes of data, hence it can be very difficult to process log files manually or using known computer tools.

Some embodiments disclosed herein are directed to a log file analysis computer that processes the content of a log file, including lines of data entries, to generate a modified log file that can be analyzed, such as by being imported into a spreadsheet program (e.g., Microsoft Excel), so that the data entries can be grouped, sorted, processed, and/or visualized for analysis by an operator or other computer equipment. When imported into a spreadsheet program, macros and other logic programming can be used to filter the data entries and separate them into column and row relative organization based on defined field types associated with the data entries.

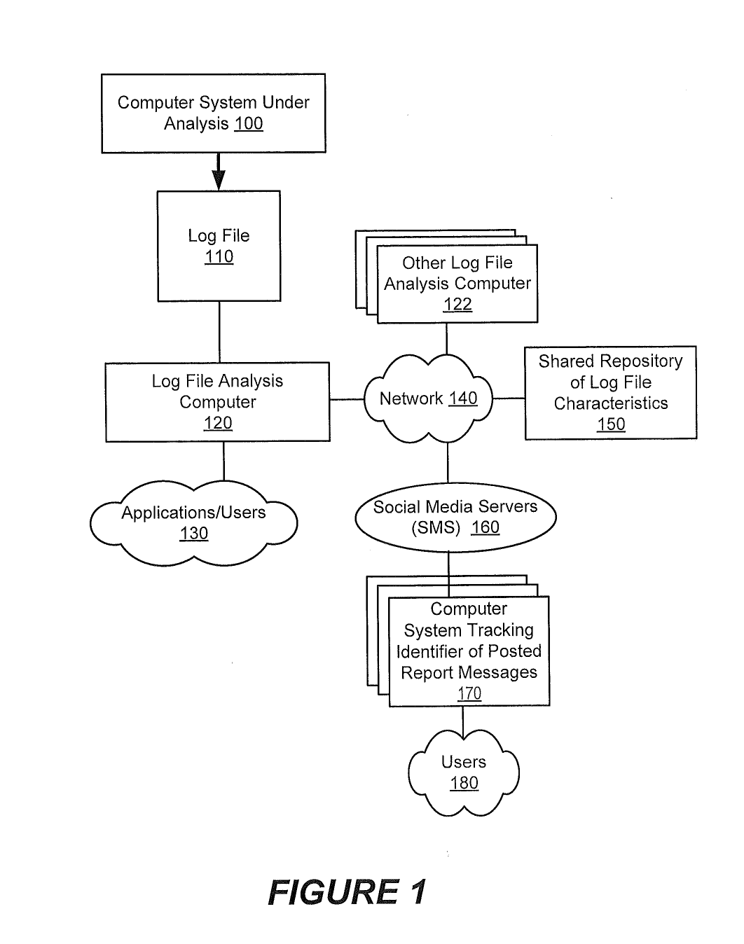

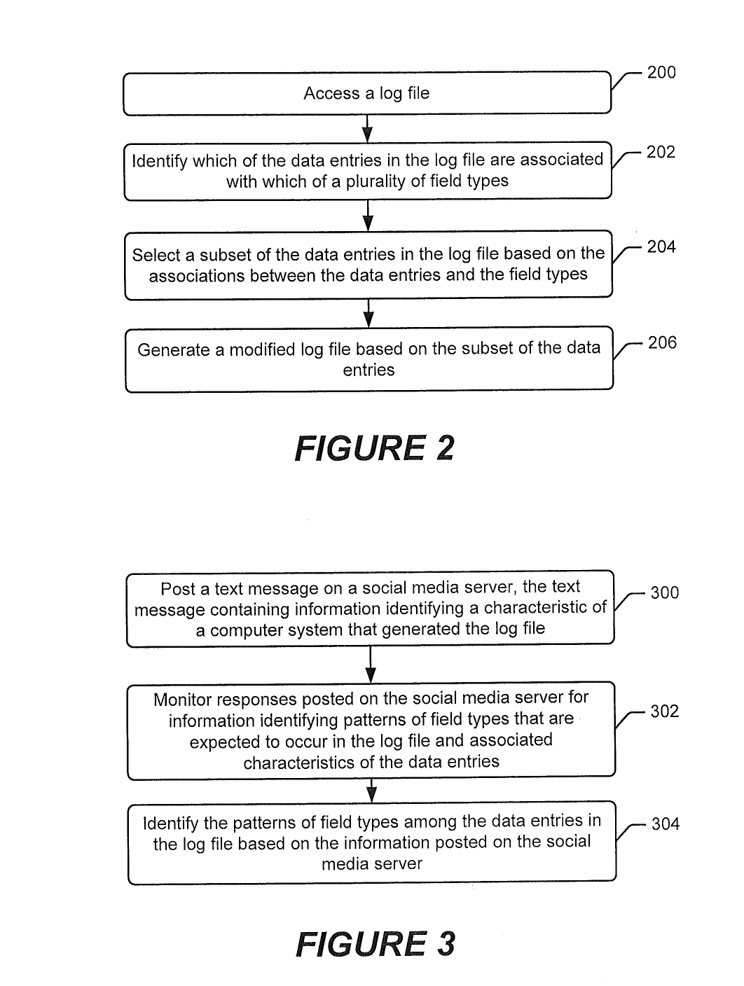

FIG. 1 is a block diagram of a system containing a log file analysis computer 120 that analyzes a log file 110 that is generated by a computer system 100 in accordance with some embodiments. FIGS. 2-6 are flowcharts of various operations and methods by a log file analysis computer, such as the computer 120, for analyzing log files in accordance with some embodiments.

Referring to FIG. 1, the computer system 100 writes data relating to its operation to the log file 110 to create data entries therein responsive to one or more defined rules being satisfied. For example, a rule may cause the computer system 100 to write data to the log file 110 responsive to occurrence of a defined event, such as detecting an operational fault, occurrence of a scheduled event (e.g., periodically at a defined interval), starting or completing a defined action (e.g., receiving/processing a request at a web server), saving checkpoint snapshot of application state information, recording changes in content of a working file, receiving communications from another program or computer system, etc. The log file 110 may also contain data entries written by other computer systems or equipment, and may reside on a network server or in another data storage memory.

The data entries may be organized into logical lines, when viewed through a text editor program. The logical lines may be constrained to a maximum length, so that a sequence of data entries, such as relating to occurrence of a same event satisfying a logging rule, are broken into two or more lines within the log file 110 at locations controlled by the maximum length of the lines.

Other optional components of the system shown in FIG. 1 will be explained further below in the context of some other embodiments.

FIG. 2 illustrates operations that may be performed by the log file analysis computer 120 to analyze content of the log file 110. Referring to FIG. 2, the log file 110 is accessed (block 200) by, for example, opening the log file 110 and then sequentially reading its data entry contents, which may be read one line at a time.

Operations identify (block 202) which of the data entries in the log file 110 are associated with which of a plurality of field types. The field types may, for example, unique name different types of data entries and/or define other characteristics of the data entries (e.g., integer/floating number/ASCII character format, acceptable range of data entry value, etc.). A subset of the data entries in the log file 110 is selected (block 204) based on the associations between the data entries and the field types. A modified log file is generated (block 206) based on the subset of the data entries. The modified log file may be imported to a spreadsheet program or other program that analyzes content of log files, and may be written back into the log file 110 or other data storage memory location.

The operations may include concatenating at least some adjacent lines of the data entries in the log file based on a defined line length constraint of the log file 110. Thus, in the context of the example log file of FIG. 8, the operations may concatenate lines to remove line breaks that were imposed due to defined line length constraints when the data entries were written to the log file 110. The displayed first and second lines can thereby be concatenated to re-join the word “advanced”, and similarly occurring breaks in sequences of text in lines 3 and 4 and some other sequentially occurring pairs of lines can be similarly concatenated. The resulting entries of the modified log file may therefore be more easily filtered or processed based on the structure of how they exist in the modified log file.

To identify which of the data entries in the log file 110 are associated with which of the field types, the operation may include accessing a local repository (716 in FIG. 7) of log file characteristics that contains information defining patterns of field types that are expected to occur in the log file 110 and associated characteristics of the data entries. Field types can be identified among the data entries in the log file 110 based on the information defining patterns of field types that are expected to occur in the log file 110 and associated characteristics of the data entries.

The repository of log file characteristics need not be local to the log file analysis computer 120. For example, referring to FIG. 1, the log file analysis computer 120 may communicate a query containing information identifying a characteristic of the computer system 100 that generated the log file 110, via a data network 140 to a shared repository 150 of log file characteristics. The query requests from the repository 150 information defining patterns of field types that are expected to occur in the log file 110 and associated characteristics of the data entries.

One or both of the repositories 716 (FIG. 7) and 150 can form a knowledge base that is created by the including log file analysis computer 120 and other log file analysis computers 122 which provide information that is useful for identifying which field types that are associated with data entries in log files. The knowledge based may furthermore identify characteristics of the data entries having such identified field types (e.g., integer/floating number/ASCII character format, acceptable range of data entry value, etc.) which can be used for identifying the field types and/or for facilitating accessing and/or analyzing data entries in log files. The information may identify data entry and field type patterns known to be created by different types of computer systems, applications hosted on the computer systems, users of computer systems, etc. Accordingly, trends can be identified across the log files generated by different computer systems, which may process a same application program whose operations are characterized by data entries in the log files. Moreover, a user of one computer system may defined field types and patterns that are expected to occur in a log file generated by a particular type of program, and the log file analysis computer 120 can access the repository using the identified of that particular type of program to obtain the defined field types, patterns, and any other defined characteristics.

The log file analysis computer 120 may obtain assistance with identifying field types of data entries in a log file and/or other analysis of the data entries through social media. For example, referring to FIG. 1, the log file analysis computer 120 may communicate with one or more social media servers 160 via a data network 140 (e.g. public/private local area network, wide area network, etc.). The social media server 160 may be, but is not limited to, a social network server (e.g., Facebook™), a blog network server (e.g., Tumbler™, server providing Web2.0 Properties/Networks, etc.), a micro blog network server 60 (e.g., Twitter™), or another social media server. The social media server 160 receives messages containing information from the log file analysis computer 120, and publishes the information to other computer systems 170 who have registered with the social media server 160 to track publishing of information on the social media server 160 by the log file analysis computer 120.

The log file analysis computer 120 can communicate information through a message posting and/or through a web feed messages (e.g., Really Simple Syndication (RSS)) to the social media server 160. The computer systems 170 can register with the social media server 160 to track publishing of information using conventional approaches directed to tracking publications identified as being from a particular person, particular device, and/or being associated with a particular subject (e.g., tracking Facebook™ friends postings, Twitter™ # message postings, etc.). The social media server 160 can publish the information by allowing the computer systems 170 to read/fetch the information from the social media server 160 and/or by delivering (e.g., pushing) the information to the computer systems 170. The computer systems 170 or users 180 that operate the computer systems 170 can analyze the published information and communicate response messages to the log file analysis computer 120. The log file analysis computer 120 may identify field types of data entries in a log file and/or perform other analysis of the data entries based on the response messages.

FIG. 3 is a flowchart of example operations that may be performed by the log file analysis computer 120 to identify which of the data entries in the log file 110 are associated with which of a plurality of field types. The operations can include posting (block 300) a text message on the social media server 160, where the text message containing information identifies a characteristic of the computer system 100 that generated the log file. The information may, for example, identify the type of computer system 100, an application hosted on the computer system 100 that wrote at least some of the data entries to the log file 110, and/or the user who operated the computer system 100 during generation of the log file 110. Responses posted on the social media server are monitored (block 302) by the log file analysis computer 120 for information identifying patterns of field types that are expected to occur in the log file 110 and associated characteristics of the data entries. The patterns of field types are identified (block 304) among the data entries in the log file based on the information posted on the social media server 160.

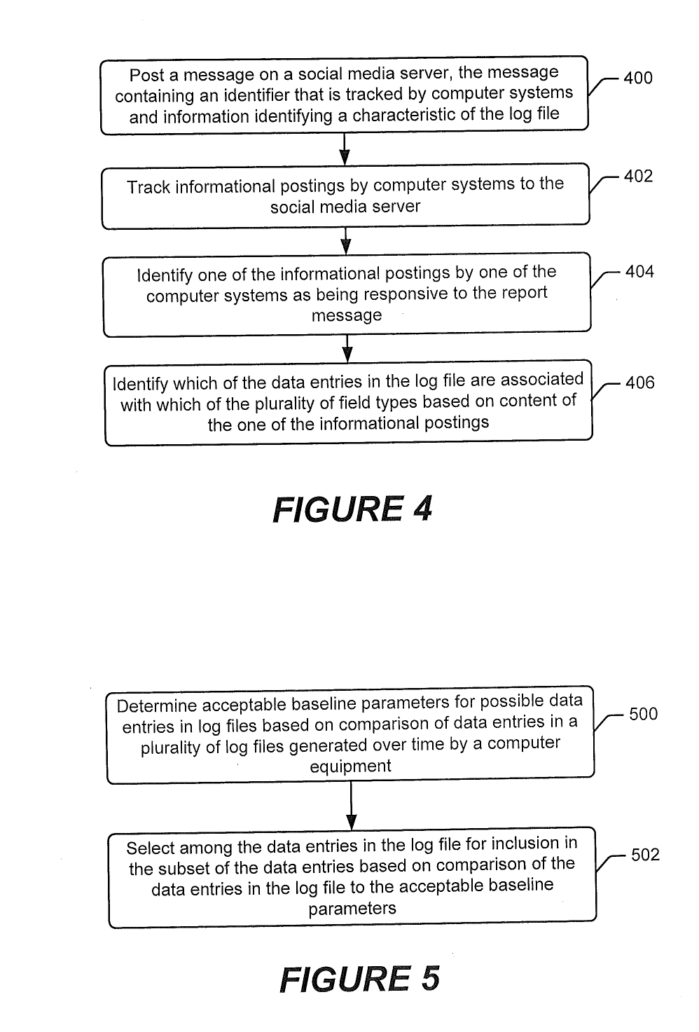

FIG. 4 is a flowchart of other example operations that may be performed by the log file analysis computer 120 to identify which of the data entries in the log file 110 are associated with which of a plurality of field types. The operations include posting (block 400) a message on the social media server 160, where the message contains an identifier that is tracked by the computer systems 170 and information identifying a characteristic of the log file 110. Information postings by the computer systems 170 to the social media server 160 are tracked (block 402). One of the information postings by one of the computer systems 170 is identified (block 404) as being responsive to the report message. The operations further identify (block 406) which of the data entries in the log file 110 are associated with which of the plurality of field types based on content of the identified one of the information postings.

In some further embodiments, the operations can include extracting information identifying patterns of field types that are expected to occur in the log file 110 and associated characteristics of the data entries based on the content of the identified one of the information postings. One of the identified patterns of field types from the information is matched to a sequence of the data entries in the log file, to identify which of the data entries in the log file 110 are associated with which of the field types.

In a further embodiment, the operations include selecting the identifier from among a plurality of defined identifiers, which are separately tracked by the computer systems 170, based on a characteristic of a computer program executed by the computer system 100 that generated the log file 110.

In a further embodiment, to post the message on the social media server 160 operations include embedding at least a portion of at least one of the lines of data entries in the log file 110 into a text string of a report message, and communicating the report message to the social media server 160 for publishing to the computer systems 170 which track the identifier.

In this manner, the log file analysis computer 120 can seek and obtain assistance from a social media community of computer systems 170 and/or users 180, who are not necessarily known or otherwise identified beforehand by the log file analysis computer 120, and who can leverage their collective knowledge base to provide desired analytical assistance to the log file analysis computer 120.

In another embodiment, the log file analysis computer 120 can perform further operations when selecting data entries in the log file 110 for inclusion in the subset of data entries, which can be provided to other applications 130, such as spreadsheet programs, for processing and/or display to users. Referring to FIG. 5, operations that the log file analysis computer 120 can use to select the subset of the data entries can include determining (block 500) acceptable baseline parameters for possible data entries in log files based on comparison of data entries in a plurality of log files generated over time by the computer system 100. A selection among the data entries in the log file 110 for inclusion in the subset of the data entries can then be made based on comparison of the data entries in the log file 110 to the acceptable baseline parameters.

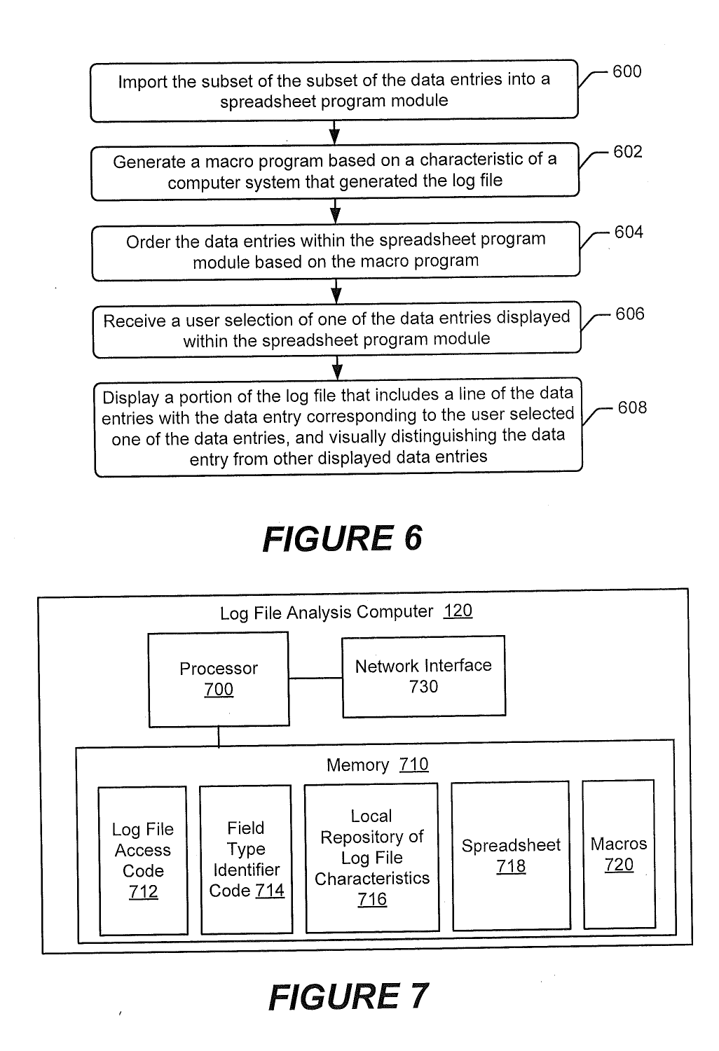

FIG. 6 illustrates further operations that can be performed by the log file analysis computer 120 to analyze the subset of the data entries from the log file 110. The operations can include importing (block 600) the subset of the subset of the data entries into a spreadsheet program module which may reside within the log file analysis computer 120 (e.g., spreadsheet program 718 in FIG. 7) or in a separate application 130 executed by a computer system. The data entries can be ordered (block 604) within the spreadsheet program module based on the field types associated with the data entries.

In one embodiment, the operations generate (block 602) a macro program based on a characteristic of the computer system 100 that generated the log file 110. The macro program can then be executed by the spreadsheet program module to perform the ordering (block 604) of the data entries.

In a further embodiment, the spreadsheet program module receives (block 606) a user selection of one of the data entries displayed within the spreadsheet program module, and displays (block 608) a portion of the log file 110 that includes a line of the data entries with the data entry corresponding to the user selected one of the data entries. When displaying the portion of the log file 110 that includes the line of the data entries with the data entry corresponding to the user selected one of the data entries, the operations may visually distinguish the data entry, which corresponds to the user selected one of the data entries, from other data entries that are displayed from the portion of the log file 110.

FIG. 7 is a block diagram of the log file analysis computer 120 of FIG. 1 configured according to one embodiment. Referring to FIG. 7, a processor 700 may include one or more data processing circuits, such as a general purpose and/or special purpose processor (e.g., microprocessor and/or digital signal processor) that may be collocated or distributed across one or more networks. The processor 700 is configured to execute computer readable program code in a memory 710, described below as a computer readable medium, to perform some or all of the operations and methods disclosed herein for one or more of the embodiments. The program code can include or more of: 1) log file access code 712 that reads and may write data entries from/to the log file 110; 2) field type identifier code 714 that identifies which of the data entries in the log file 110 are associated with which of a plurality of field types; 3) a local repository of log file characteristics 716 that identifies characteristics of filed types that can be compared to data entries in the log file 110 by the field type identifier code 714 to determine the field type associations for the data entries; 4) a spreadsheet program 718, and 5) macro programs 720 executable by the spreadsheet program 718. A network interface 730 can communicatively connect the processor 700 to the log file 110 and other components of the system, such as the components shown in FIG. 1.

Non-limiting example embodiments that illustrate operations for retrieving and processing data entries in a log file are further explained below with regard to FIGS. 9-18.

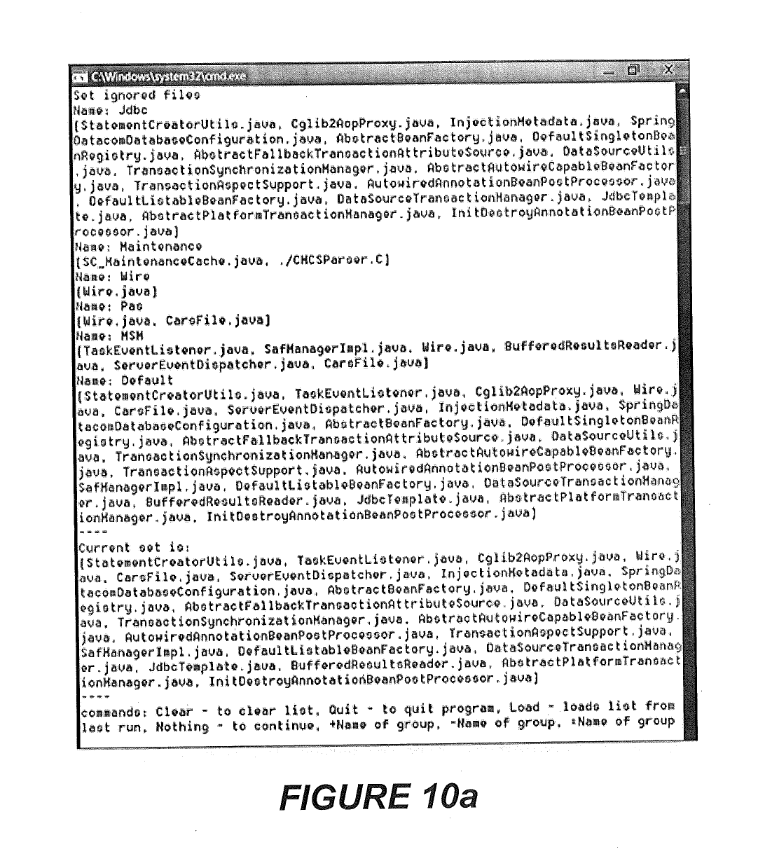

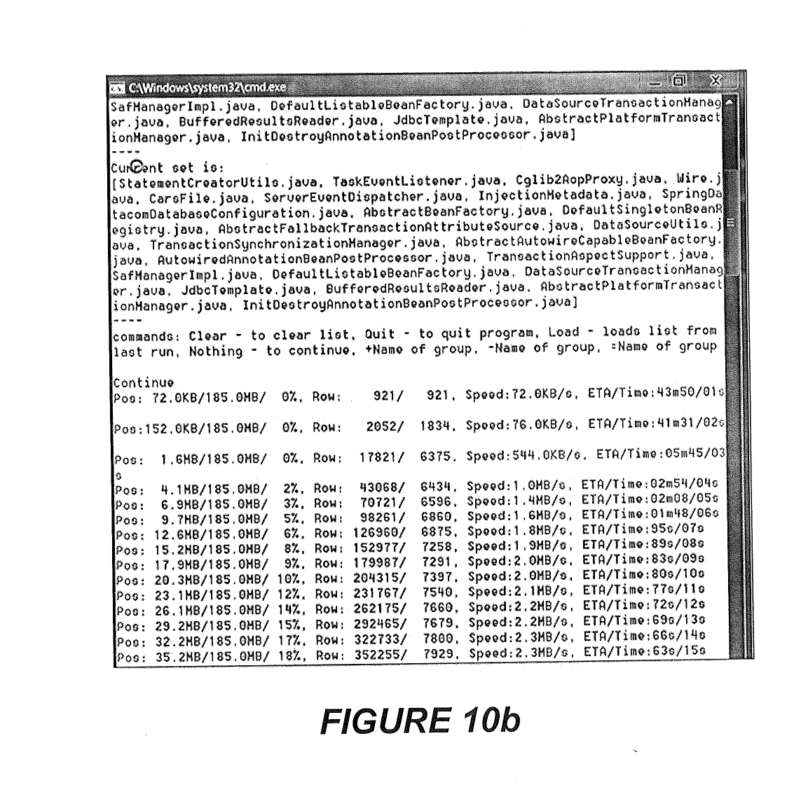

Referring to FIG. 9, a log file is opened (e.g., command ctrl+l). FIGS. 10a and 10b illustrate a Java application that can be executed by a log file analysis computer to parse data entries in a log file and define data entries of the log file that are not to be imported. The Java application concatenates broken long lines of data entries in the log file to reconstruct the data was written to the log file by one or more computer systems. The Java application further analyzes the data entries to identify the associated field types.

For example, the Java application reads data entries from the log file containing “DEBUG (http-32120-3#getProduct) 2013-09-23 10:27:31,579 (SCProxySettings.java:276): * proxy server: on”. The Java application parses the data entries and identifies the associated field types, as follows:
field type Severity corresponding to data entry “DEBUG”;
field type Name of thread corresponding to data entry “http-32120-3#getProduct”;
field type Date and time (when message was issued corresponding) to data entry “2013-09-23 10:27:31,579”;
field type File name: line number (place in source code where this message comes from) responding to data entry “SCProxySettings.java:276”; and
field type Body of message (actual content of message) corresponding to data entry “* proxy server: on”.

The Java application filters out messages based on user input, e.g., to reduce number of lines that will be output as a modified log file (e.g., comma-separated-value (CSV) file). The Java application extracts statistics, such as: the number of threads; number of Debug, Error, Info, Warn, Fatal messages; and any user defined statistics. The Java application writes the data entries and associated filed types to a modified log file, which may be a CSV file for input to a spreadsheet program (e.g., Microsoft Excel).

The CSV file can be imported into a spreadsheet program. When imported into the spreadsheet program, macros and other logic programming can be used to filter the data entries and separate them into column and row relative organization based on defined field types associated with the data entries.

The Java application may generate a macro program that is performed by the spreadsheet program to automate the visual presentation and/or analysis of the data entries that are imported. The macro program can be generated based on information that identifies content of the log file and/or characteristics of the computer system that wrote data to the log file. The macro program and/or a user can operate the spreadsheet to browse the data entries that are structured according to their field types, and may filter the data entries based on the field types and/or values of data entries of the defined field types.

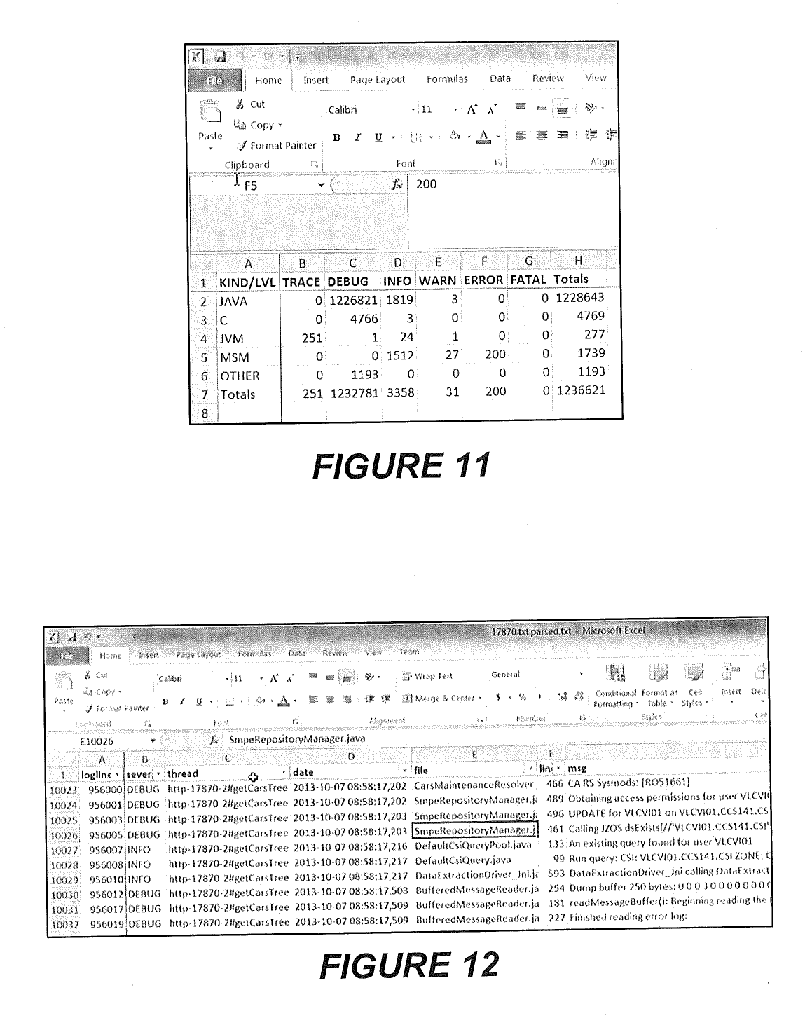

For example, FIG. 11 illustrates a portion of a spreadsheet program window that organizes rows of data entries under columns of different associated field types, where the data entries have been imported from the output of the Java application. The data entries can be sorted by one or more of the columns of field types, such as their debug status, information identifier, warning level, error level, etc. The data entries can be sorted to present only those having at least a defined severity level and/or which contain defined values/text.

In FIG. 12, spreadsheet operations are performed to filter the data based on the sorted column characteristics. A data entry within the spreadsheet has been automatically highlighted for the attention of a user, based on operation of a macro program that searched through the data entries based on their values. The data entries from the log file can be compared to data entries from other log files to determine whether any of the data entries are to be highlighted for presentation to the user. For example, a data entry from the log file having a value that is outside of an observed range of values identified for the corresponding data entry in other log files (e.g., earlier log files from the same or other computer system) can be processed to perform further analysis on that data entry and/or can be presented to a user.

The sorting and filtering may be carried out by the macro program responsive to a user command. The macro program can be initiated by a user to start the Java application which parses and processes the log file to generate a modified log file that is loaded into the spreadsheet program. The macro program may setup the layout and structure of the data entries within the spreadsheet program.

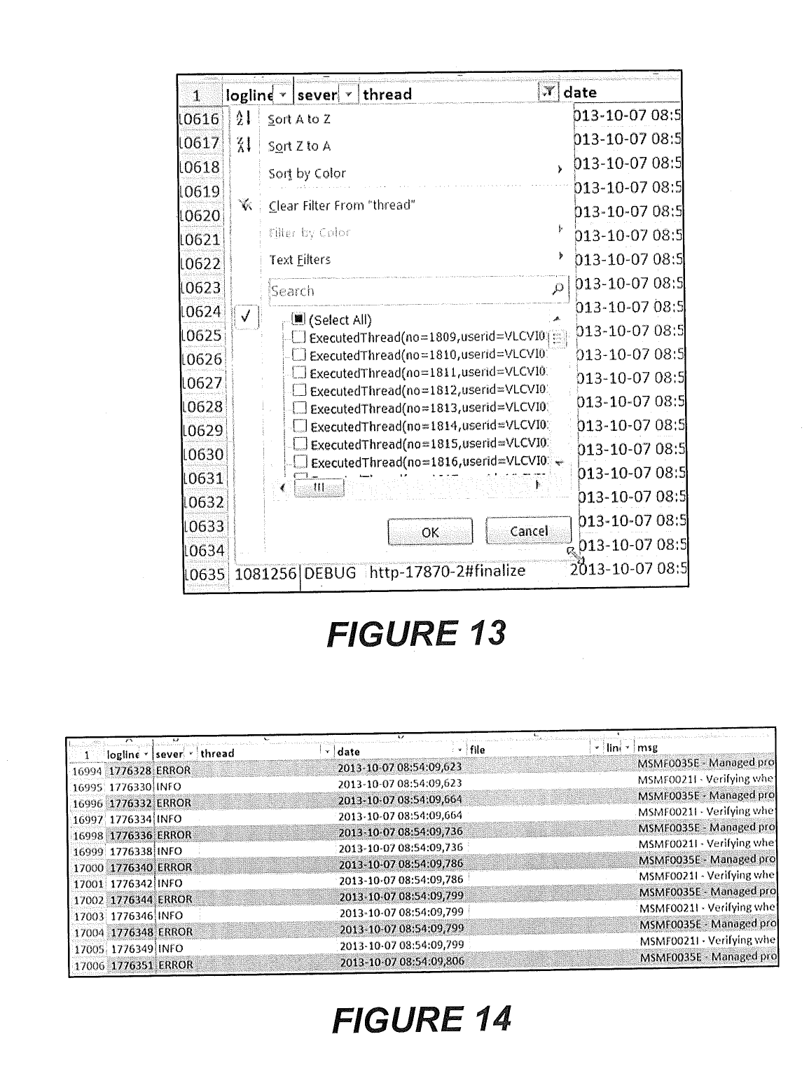

FIG. 12 illustrates another portion of the spreadsheet program that has been reformatted to provide a structured view of the data imported from the log parser Java executable program. In FIG. 13, the user can select among the displayed field types of the columns to cause the spreadsheet to filter the data entries.

In FIG. 14, the filtered data entries are displayed with visual indications of which of the rows of the data entries satisfy defined rules (e.g., highlight rows having “error” status, using different colors to display data/statistics from different file systems or applications). The visual indications enable a user to more quickly scan through the voluminous information to identify operational characteristics for further analysis.

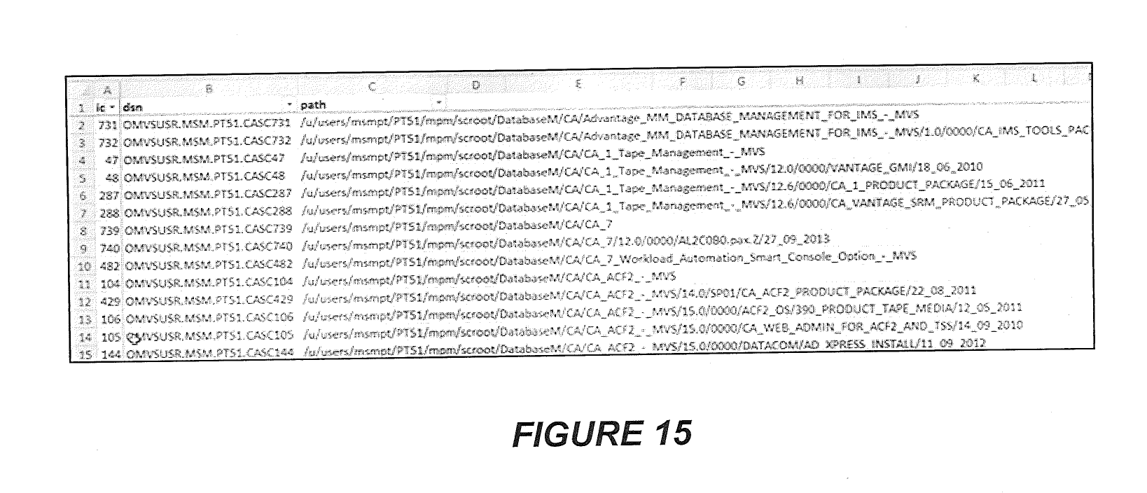

FIG. 15 illustrates statistics generated by a macro program which identify file systems that have been determined from the data entries to have been used during operation of the computer system that generated the log file.

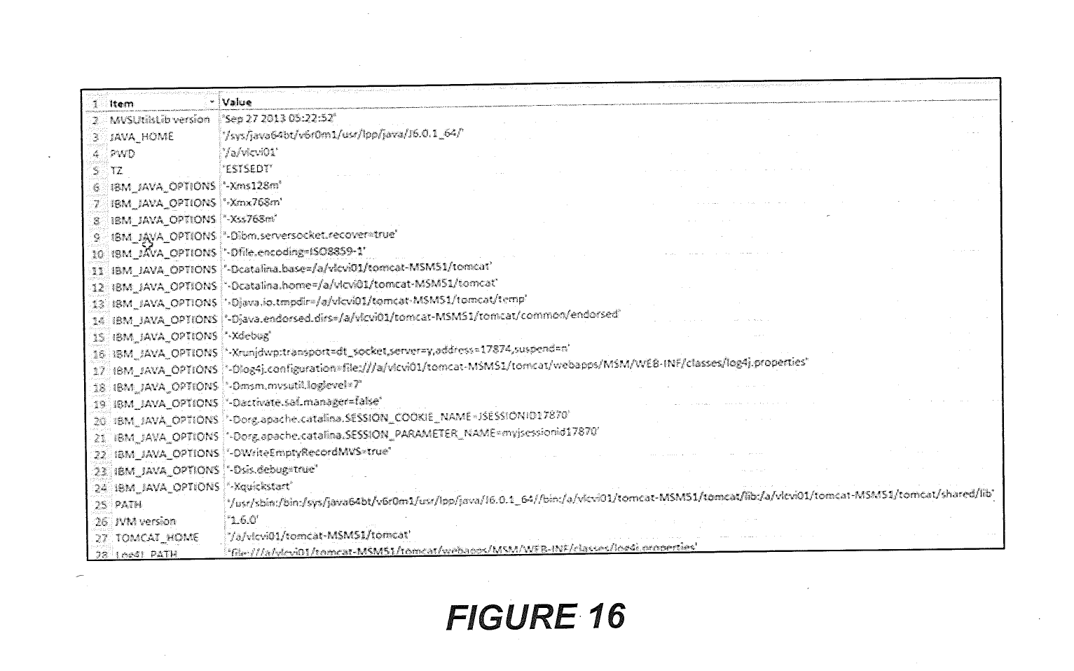

FIG. 16 illustrates other statistics that are generated by the macro program which identify the field types that are associated with the data entries of the log file.

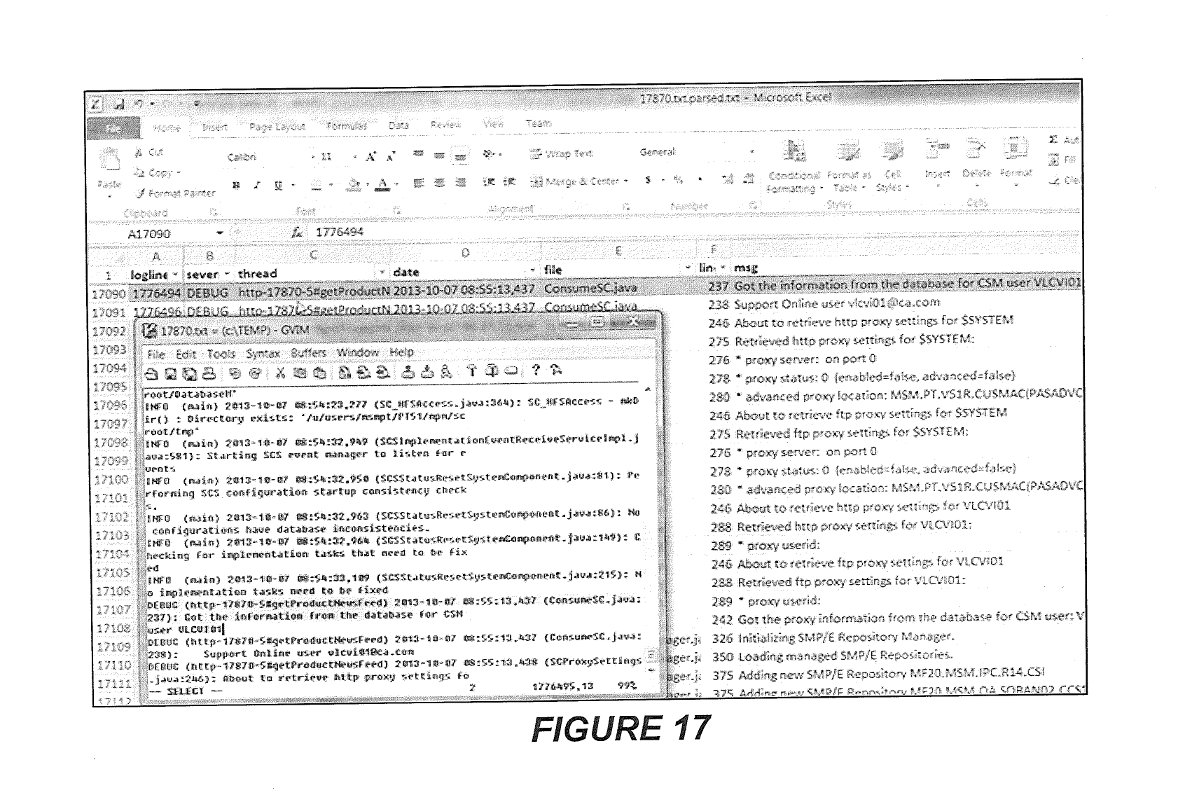

Referring to FIG. 17, a user may select one of the displayed lines within the spreadsheet program (background window) to cause a corresponding highlighted location with the original log file to be displayed (foreground window), under operation of a macro program or other program which be executed by a log file analysis computer. For example, in FIG. 17 a user has selected row 17090 in the background window of the spreadsheet window which triggers another window to be displayed in the foreground that shows the corresponding line containing the data entries of the selected line and further shows a defined number of adjacent lines from the original log file. A user may thereby analyze the data entries that are structured and organized in the spreadsheet program, and select a displayed line or data entry thereof to cause the corresponding location in the original log file to be displayed in a separate window to allow further analysis by the user.

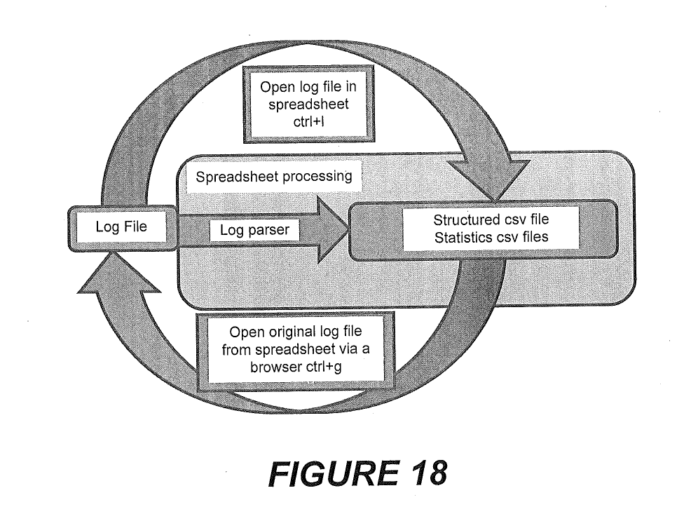

FIG. 18 illustrates an example overview of a workflow scheme according to some embodiments. A log file is generated from data entries that are written during operation of an application and/or operating system executed by a computer system. A log parser executable program, which may be part of a spreadsheet program or other program of a log file analysis computer, processes the data entries from the log file (e.g., rejoining split lines of data entries, sorting data entries, filtering data entries, etc) to output a modified log file that is imported to a spreadsheet program for processing. The spreadsheet program can output a filtered, sorted, etc., structured data to a CSV file, and may output statistics generated from the data to the same or other CSV file.

Further embodiments can include:

The data entries of spreadsheets generated from a sequence of earlier log files can be compared to identify events or sequences of events that are of-interest relating to system/application operation. For example, comparing data entries across a set of log files can enable a user to determine if operational changes that have been made to a system/application are having desired/undesired results (e.g., reducing/increasing occurrence of errors and/or type/severity of errors). A knowledge base may be generated based on the analysis of log files to identify acceptable baseline parameters for future comparison, and/or to identify acceptable/unacceptable patterns over time of data entries within log files.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A log file analysis computer comprising:
a processor; and
a memory coupled to the processor and comprising computer readable program code that when executed by the processor causes the processor to perform operations comprising:
accessing a log file containing lines of data entries;
identifying which of the data entries in the log file are associated with which of a plurality of field types;
selecting a subset of the data entries in the log file based on the associations between the data entries and the field types; and
generating a modified log file based on the subset of the data entries.

2. The log file analysis computer of claim 1, wherein the operations further comprise:
concatenating at least some adjacent lines of the data entries in the log file based on a defined line length constraint of the log file.

3. The log file analysis computer of claim 1, wherein identifying which of the data entries in the log file are associated with which of a plurality of field types, comprises:
accessing a local repository of log file characteristics that contains information defining patterns of field types that are expected to occur in the log file and associated characteristics of the data entries; and
identifying the field types among the data entries in the log file based on the information defining patterns of field types that are expected to occur in the log file and associated characteristics of the data entries.

4. The log file analysis computer of claim 1, wherein identifying which of the data entries in the log file are associated with which of a plurality of field types, comprises:
communicating a query, containing information identifying a characteristic of a computer system that generated the log file, via a data network to a shared repository of log file characteristics requesting information defining patterns of field types that are expected to occur in the log file and associated characteristics of the data entries; and
identifying the patterns of field types among the data entries in the log file based on the information.

5. The log file analysis computer of claim 1, wherein identifying which of the data entries in the log file are associated with which of a plurality of field types, comprises:
posting a text message on a social media server, the text message containing information identifying a characteristic of a computer system that generated the log file;
monitoring responses posted on the social media server for information identifying patterns of field types that are expected to occur in the log file and associated characteristics of the data entries; and
identifying the patterns of field types among the data entries in the log file based on the information posted on the social media server.

6. The log file analysis computer of claim 1, wherein identifying which of the data entries in the log file are associated with which of a plurality of field types, comprises:
posting a message on a social media server, the message containing an identifier that is tracked by computer systems and information identifying a characteristic of the log file;
tracking informational postings made by computer systems to the social media server; and
identifying one of the informational postings by one of the computer systems as being responsive to the report message; and
identifying which of the data entries in the log file are associated with which of the plurality of field types based on content of the identified one of the informational postings.

7. The log file analysis computer of claim 6, wherein identifying which of the data entries in the log file are associated with which of the plurality of field types based on content of the identified one of the informational postings, comprises:
extracting information identifying patterns of field types that are expected to occur in the log file and associated characteristics of the data entries based on the content of the identified one of the informational postings; and
matching one of the identified patterns of field types from the information to a sequence of the data entries in the log file.

8. The log file analysis computer of claim 6, wherein the operations further comprise:
selecting the identifier from among a plurality of defined identifiers, which are separately tracked by computer systems, based on a characteristic of a computer program executed by a computer system that generated the log file.

9. The log file analysis computer of claim 6, wherein posting a message on a social media server, the message containing an identifier that is tracked by computer systems and information identifying a characteristic of the log file, comprises:
embedding at least a portion of at least one of the lines of data entries in the log file into a text string of a report message; and
communicating the report message to the social media server for publishing to the computer systems which track the identifier.

10. The log file analysis computer of claim 1, wherein selecting a subset of the data entries in the log file based on the associations between the data entries and the field types, comprises:
determining acceptable baseline parameters for possible data entries in log files based on comparison of data entries in a plurality of log files generated over time by a computer system; and
selecting among the data entries in the log file for inclusion in the subset of the data entries based on comparison of the data entries in the log file to the acceptable baseline parameters.

11. The log file analysis computer of claim 1, wherein the operations further comprise:
importing the subset of the subset of the data entries into a spreadsheet program module; and
ordering the data entries within the spreadsheet program module based on the field types associated with the data entries.

12. The log file analysis computer of claim 1, wherein the operations further comprise:
importing the subset of the subset of the data entries into a spreadsheet program module;
generating a macro program based on a characteristic of a computer system that generated the log file; and
ordering the data entries within the spreadsheet program module based on the macro program.

13. The log file analysis computer of claim 1, wherein the operations further comprise:
receiving a user selection of one of the data entries displayed within the spreadsheet program module; and
displaying a portion of the log file that includes a line of the data entries with the data entry corresponding to the user selected one of the data entries.

14. The log file analysis computer of claim 13, wherein displaying the portion of the log file that includes the line of the data entries with the data entry corresponding to the user selected one of the data entries, comprises:
visually distinguishing the data entry, which corresponds to the user selected one of the data entries, from other data entries that are displayed from the portion of the log file.

15. A method in a log file analysis computer, the method comprising:
accessing a log file containing lines of data entries;
identifying which of the data entries in the log file are associated with which of a plurality of field types;
selecting a subset of the data entries in the log file based on the associations between the data entries and the field types; and
generating a modified log file based on the subset of the data entries.

16. The method of claim 1, wherein identifying which of the data entries in the log file are associated with which of a plurality of field types, comprises:
accessing a local repository of log file characteristics that contains information defining patterns of field types that are expected to occur in the log file and associated characteristics of the data entries; and
identifying the field types among the data entries in the log file based on the information defining patterns of field types that are expected to occur in the log file and associated characteristics of the data entries.

17. The method of claim 1, wherein identifying which of the data entries in the log file are associated with which of a plurality of field types, comprises:
posting a message on a social media server, the message containing an identifier that is tracked by computer systems and information identifying a characteristic of the log file;
tracking informational postings made by computer systems to the social media server; and
identifying one of the informational postings by one of the computer systems as being responsive to the report message; and
identifying which of the data entries in the log file are associated with which of the plurality of field types based on content of the identified one of the informational postings.

18. The method of claim 17, further comprising:
selecting the identifier from among a plurality of defined identifiers, which are separately tracked by computer systems, based on a characteristic of a computer program executed by a computer system that generated the log file,
wherein posting a message on a social media server, the message containing an identifier that is tracked by computer systems and information identifying a characteristic of the log file, comprises:
embedding at least a portion of at least one of the lines of data entries in the log file into a text string of a report message; and
communicating the report message to the social media server for publishing to the computer systems which track the identifier.

19. The method of claim 1, wherein selecting a subset of the data entries in the log file based on the associations between the data entries and the field types, comprises:
determining acceptable baseline parameters for possible data entries in log files based on comparison of data entries in a plurality of log files generated over time by a computer system; and
selecting among the data entries in the log file for inclusion in the subset of the data entries based on comparison of the data entries in the log file to the acceptable baseline parameters.

20. The method of claim 1, wherein the operations further comprise:
importing the subset of the subset of the data entries into a spreadsheet program module;
generating a macro program based on a characteristic of a computer system that generated the log file; and
ordering the data entries within the spreadsheet program module based on the macro program.
